(19) United States
(12) Patent Application Publication
(10) Pub. No.: US 2003/0215273 A1
(43) Pub. Date: Nov. 20, 2003

(54) Image forming apparatus

(76) Inventors: Yasushi Kinoshita, Toride (JP); Shigeru Obata, Ishioka (JP); Kazutaka Sato, Kashiwa (JP); Isao Nakajima, Hitachinaka (JP); Akitomo Kuwabara, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/229,063

(22) Filed: Aug. 28, 2002

(30) Foreign Application Priority Data
May 17, 2002 (JP) 2002-142289

(51) Int. Cl. G03G 15/00

(52) U.S. Cl. 399/384

(57) ABSTRACT

An image forming apparatus characterized by the minimum image deterioration. The surface of a feed roller immediately after a fixing unit is covered with a mold release member to improve the mold release property of molten toner, and cooling means for forcible cooling of a web and a feed roller to improve the coagulation of molten toner, whereby high temperature offset is avoided. Further, a heat insulating member is arranged inside the mold release member of the feed roller, thereby increasing the thermal time constant, ensuring a quick cooling cycle and reducing the thermal expansion of the feed roller.

### BACKGROUND OF THE INVENTION

1. Field of the Invention

The present invention relates to an image forming apparatus for forming a toner image on both sides of continuous paper used in a duplex copying machine or the like.

2. Prior Art

One of the problems in an image forming apparatus for forming a toner image on both sides of a web is how to hold and feed the web subsequent to toner image transfer. Usually, the web is held and fed either before or after the step of fixing.

The web before the step of fixing contains toner powder transferred at the image forming unit. If the web under this condition is held and fed by the feed roller, part of the toner powder is reversely transferred to feed roller at the contact section between the feed roller and web. This will give rise to such problems as reduced transfer efficiency due to loss of toner, changes in color, occurrence of an offset image due to re-transfer of reversely transferred toner, and color mixture.

Further, the toner image may be crushed by the mechanical contact of the feed roller, resulting in deterioration of image quality. One of the efforts to solve these problems is found in the electrostatographic copying machine or printing machine disclosed in Japanese Application Patent Laid-Open Publication No. Hei 07-334061, wherein electrostatic attraction of the web and toner particles is enhanced by application of electrical charge to the web, and reverse transfer of toner particles is prevented by application of bias to the feed roller.

In the feed roller cleaning apparatus of the electrophotographic apparatus disclosed in Japanese Application Patent Laid-Open Publication No. Hei 10-198092, reversely transferred toner particles on the feed roller is removed by this cleaning apparatus, thereby preventing the offset image from occurring.

The toner molten by heating by a fixing unit is attached to the web after the step of fixing. The feed roller receives heat from the web and molten toner, and reaches a high temperature. This tends to cause high-temperature offset of toner. The same image deterioration as that in the case of no-fixed toner is caused by the toner reversely transferred on the feed roller.

Further, since the feed roller is subjected to heat expansion, the feed accuracy will be deteriorated and a color registration error will occur. The method of feeding the web after the step of fixing will give rise to heat problems as discussed above, so the method of feeding the web before the step of fixing is commonly used.

According to the prior art, the web feed method is used where unfixed toner is attached to the web without heat being transferred to the feed roller. However, reverse transfer of the toner to the feed roller cannot be reduced to zero, with the result that such problems as change in coloring and occurrence of offset image remain. Thus, it has been difficult to ensure an image with excellent reproducibility.

### SUMMARY OF THE INVENTION

An object of the present invention is to provide a image forming apparatus ensuring an image characterized by excellent reproducibility.

To achieve the above object, the present invention uses the method of feeding a web after it has passed through the fixing unit. The feed roller temperature may gradually be raised by the heat of the web and toner image, possibly resulting in considerably higher-temperature offset of molten toner, hence image defects such as image offset, increased dimensional error and eccentricity, or deteriorated feed performances.

These problems can be solved by coating the surface of the roller with a member characterized by excellent mold release property, thereby preventing the molten toner from reversely transferring, or by providing cooling means for cooling the web down to the temperature where high-temperature offset does not occur.

Providing the feed roller with a heat insulation layer, thereby increasing the thermal time constant can ensure dimensional stability. This can be done by arranging a heat insulating member of low thermal conductivity inside the mold releasing member of the feed roller. This enables the molten toner image to be held and fed, and provides an image forming apparatus characterized by excellent reproducibility.

### BRIEF DESCRIPTION OF DRAWINGS

FIG. 1 is a drawing representing the configuration of an image forming apparatus as the first embodiment of the present invention;

FIG. 2 is a cross sectional view representing the configuration of a feed roller in the first embodiment of the present invention;

FIG. 3 is a drawing representing the periphery of a feed roller in the first embodiment of the present invention;

FIG. 4 is a cross sectional view representing the configuration of a feed roller in the second embodiment of the present invention;

FIG. 5 is a cross sectional view representing the configuration of a feed belt in the second embodiment of the present invention;

FIG. 6 is a cross sectional view representing the coagulation of toner in the second embodiment of the present invention;

FIG. 7 is a drawing representing the relationship of temperature on the periphery of the feed roller in the third embodiment of the prevent invention; and

FIG. 8 is a drawing representing the temperature adjusting means in the third embodiment of the prevent invention.

### DETAILED DESCRIPTION OF THE INVENTION

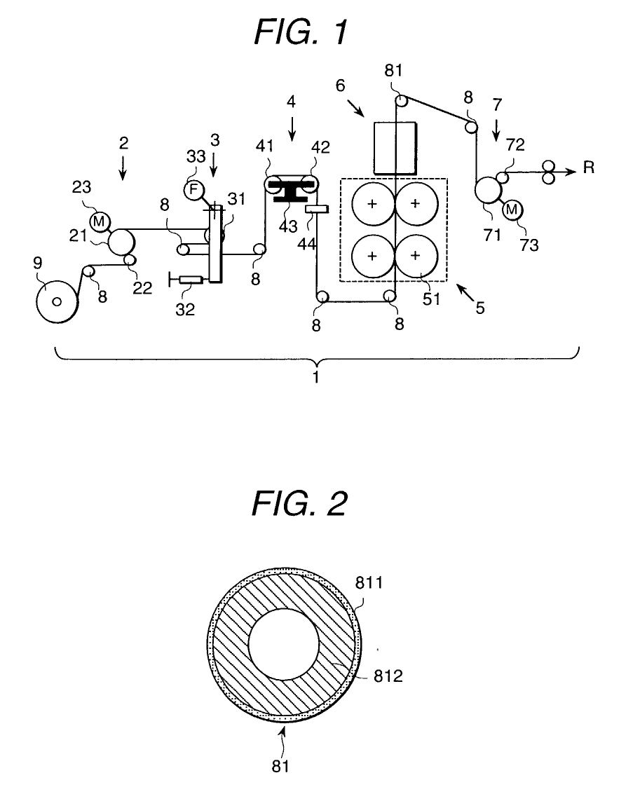

FIG. 1 is a drawing representing the configuration of an image forming apparatus as the first embodiment according to the present invention.

An image forming apparatus 1 comprises an infeed unit 2, a tension controller 3, a walk controller 4, an image forming unit 5, fixing unit 6, an outfeed unit 7, and a feed roller 8. A web 9 is routed through the aforementioned units sequentially in the above-mentioned order to form a feed path R.

The web 9 is a web where continuous paper such as rolled paper supplied in the form wound in a roll or box paper supplied in a form folded in a certain length is used. A pre-processor (not illustrated) straightens the web 9 and curling resulting from winding or folding is removed. Then it is fed to the infeed unit 2.

The infeed unit 2 comprises an infeed roller 21 and back roller 22. The infeed roller 21 is equipped with a drive motor 23. The web 9 is wound on the infeed roller 21 to secure the width for contact. At the same time, the drive force of the drive motor 23 is effectively transmitted without slipping when pressed by the back roller 22.

The tension controller 3 comprises a dancer roller 31, a loading means 32 and a position detector 33. The dancer roll 31 is a suspended from the web 9, and moves freely in the vertical direction. The dancer roll 31 has a function of applying tension to the web 9 by loading means 32 such as its own dead weight, spring force or cylinder pressure. If an abrupt change in tension occurs, the dancer roller 31 absorbs it by changing its own position, thereby ensuring a constant tension at all times.

A control system is configured in such a way that the position of the dancer roller 31 is detected by the position detector 33, and the speed of the infeed roller 21 is fine-adjusted in conformity to the amount of traveling, thereby ensuring return to a predetermined position.

The walk controller 4 comprises two correction rollers 41 and 42 arranged in parallel, a turn table 43 for securing their roller shafts and rotating together with correction rollers 41 and 42, and a walk sensor 44. The walk sensor 44 detects the walk of the web 9, and the turn table 43 rotates in response to the amount of walking. Two correction rollers 41 and 42 are tilted in the direction of feed by the rotation of the turn table 43, whereby the traveling position of the web 9 is corrected.

The image forming unit 5 forms a toner image by an image forming unit 51 based on electrophotographic process, thereby allowing transfer onto the web 9. Duplex printing is enabled by image forming units 51 arranged on the front and back of the web 9. Multiple images forming units 51 can be arranged to permit formation of colored image.

The fixing apparatus 6 is installed to dry and fix an image on the web 9. If the feed speed is high, the time of contact between the web 9 and fixing roller is short in the roller fixing unit, it is difficult to ensure a sufficient amount of heat to melt the toner. To solve this problem, use of a non-contact type oven fixing unit is preferred. Since the oven fixing unit is designed in a non-contact configuration, an excellent image free of image crushing can be obtained.

The outfeed unit 7 is designed in the same configuration as the infeed unit 2, and comprises an outfeed roller 71, a back roller 72 and a drive motor 73. The outfeeder 71 is controlled to provide a constant feed speed, and is used as a reference for the web feed speed of the image forming unit 5.

The feed roller 8 is used to change the direction of the feed direction of the web 9, as required, so as to pass through the tension controller 3, walk controller 4, image forming unit 5 and fixing unit 6 installed on the path from the infeed unit 2 to the outfeed unit 7. Since the dimensional accuracy and eccentricity of the feed roller 8 affects the feed rate accuracy of the web 9, the feed roller 8 is manufactured to a high precision.

The following describes the function of the feed roller 81 of the first embodiment.

The high speed color printer has a long path since the web passes through four-color image forming unit 51. Further, the fixing unit 6 is required to have a long heating zone proportional to the speed in order to apply a sufficient amount of heat. Accordingly, the apparatus tends to be increased in size. In response to the increased size, feed rollers 81 are arranged at given positions on the above-mentioned path, and the path of the web 9 is folded to provide a compact layout.

In the prior art, arranging a feed roller 81 between the image forming unit 5 to the fixing unit 6 and folding it provides a compact configuration. However, this involves such problems as an offset image resulting from the reverse transfer of the unfixed toner image on the web 9 in contact with the feed roller 81, and image deterioration caused by changes in coloring. In the present embodiment, the feed roller 81 is installed immediately after the fixing unit 6. Bringing in contact after fixing toner onto the web 9 reduces reverse transfer and toner loss.

Installation of the feed roller 81 immediately after the fixing unit 6 allows the feed roller 81 to be heated by the web 9 and molten toner in contact, and its temperature rises to the level close to the fixing temperature.

When the temperature at the point of contact between the feed roller 81 and web has risen close to the fixing temperature, coagulation of the molten toner is weak, resulting in a high temperature offset where toner is separated to both of the feed roller 81 and web 9. The molten toner distribution rate in this case vary according to the adhesion between the feed roller 81 and toner, and adhesion between the web 9 and toner.

FIG. 2 is a cross sectional view representing the configuration of the feed roller 81 as the first embodiment. It shows the configuration where the surface of the feed roller 81 is covered with a member 811 having an excellent mold release property. Such a configuration improves the mold release property on the surface of the feed roller 81, and adhesion between the feed roller 81 and toner is reduced, whereby the mount of toner reversely transferred from the web 9 to the feed roller 81 is reduced.

The member 811 having an excellent mold release property can be represented by fluorine resin and silicone resin. However, since the feed roller 81 is heated to a high temperature, heat resistance is essential.

PFA and PTFE are preferred as fluorine resin, and thermoplastic silicone rubber is suitable as a silicone resin. When these mold release members are used, the surface of the feed roller 81 can be coated by spraying or coated with a tubular resin. Here the feed roller 81 is required to provide an excellent mold release property and high feed accuracy. So the mold release member 811 is preferably coated directly onto the metallic roller that allows a high degree of dimensional accuracy to be obtained.

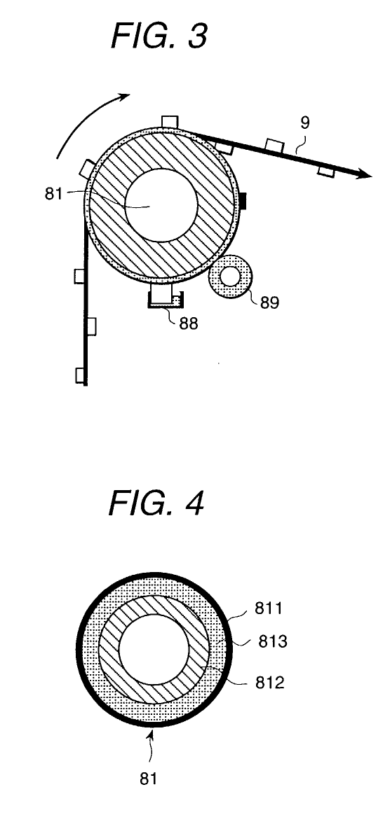

Mold release property of the feed roller 81 can be further improved by applying silicone oil on the surface thereof, whereby the reverse transfer preventing effect is enhanced. Oil application means 88 is provided on the periphery of the feed roller 81 just before the feed roller 81 and web 9 are brought in contact with each other, as shown in FIG. 3. A thin layer of silicone oil is applied on the surface of the feed roller 81 by an oil pad or the like, thereby realizing the above-mentioned effect.

The molten toner reversely transferred to the feed roller 81 is almost reduced to zero by application of the mold release member 811 and silicone oil. But there are very few cases where a very small amount of toner is reversely transferred. Reversely transferred toner is again transferred to the web 9 after one rotation to come into contact with the web 9. This will result in an offset image. The offset image can be completely eliminated by cleaning before contact with the web 9.

Cleaning means 89 is can be provided by bringing a felt-made cleaning pad or felt roller in contact with the feed roller. The cleaning means 89 is preferably placed on the upstream side of the oil application means 88. Even if complete cleaning has failed, transfer to the web 9 can be prevented by application of silicone oil to the remaining.

The following describes the second embodiment according to the present invention.

FIG. 4 is a drawing representing the configuration of the feed roller 81 as a second embodiment.

The feed roller 81 arranged immediately after the fixing unit 6 is heated by the web 9 and molten toner, and the temperature is gradually raised. So the dimensional error, eccentricity and runout are increased by the thermal expansion of the roller itself. Such a dimensional variation appears as a speed variation when the web 9 is wound and fed. It affects the image forming unit 5 to cause jitter or color misregistration.

Further, the web 9 winding around the feed roller 81 is subjected to the extra heat of the feed roller 81 for a long time when feed is stopped, so curling is produced at the wound position to cause crumples of the web. This may cause fracture of the web.

For the reasons described above, a member having a low heat conductivity (heat insulating member 813) is arranged inside the mold release member 811 on the surface of the feed roller 81 in order to keep down the temperature rise of the feed roller 81. The feed roller 81 of the second embodiment is designed in three layer structure consisting of a mold release member 811, heat insulating member 813 and cored bar member 812, as viewed from the surface.

The material having a low heat conductivity or foamed material containing an extremely fine air layer in the material can be used as material for the heat insulating member 813. The glass fiber has a minute air layer among fibers, and a very small heat conductivity to keep down convection. It has excellent heat resistance, strength and dimensional accuracy, and provides the optimum material as heat insulating member 813.

When the feed roller 81 is configured in this manner, heat is not transmitted to the internal cored bar member 812 by the heat insulating member 813, so only the surface of the feed roller 81 is heated, and thermal expansion of the feed roller 81 can be reduced. If the thickness of the mold release member 811 and heat insulating member 813 is decreased, the high dimensional accuracy of the cored bar member 812 can be utilized.

So even if heated, high precision feed can be realized. Further, the incoming and outgoing heat of the feed roller 81 is limited only to the surface member, and heat capacity is reduced, with the result that the feed roller 81 becomes easy to heat and easy to cool. Accordingly, extra heat of the feed roller 81 is discharged instantly. Adverse effect upon the web 9 can be eliminated.

Generally, the fluorine resin and silicone resin used in the mold release member 811 has the thermal time constant that is smaller than metal. Accordingly, the heat of the web 9 and molten toner cannot be efficiently absorbed and discharged.

Therefore, a thin metal is provided between the mold release member 811 and heat insulating member 813, taking advantage of the fact that the thermal time constant of metal is high. In this way, thermal time constant is improved and efficient heat absorption and discharge can be made.

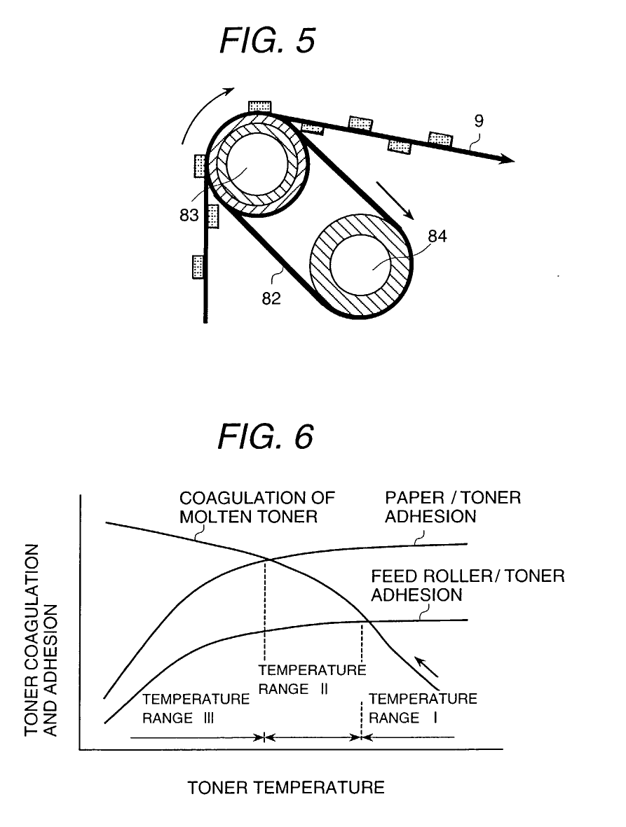

A feed belt 82 can be used to get the same effect as that of the feed roller 81 of the second embodiment. FIG. 5 shows an example of the configuration using the feed belt 82.

The substrate of the feed belt 82 is made of polyimide having an excellent resistance to heat. The surface consists of a seamless belt coated with the mold release member 811. The belt feed roller 83 on the side in contact with the web 9 has a layer of heat insulating member 813 to prevent heat from being accumulated. In the meantime, a configuration allowing high-precision feed is preferred to avoid slippage between the heat belt 82 and web 9.

The following describes a third embodiment of the present invention

FIGS. 6, 7 and 8 are drawings for explaining the third embodiment.

Molten toner has a high degree of toner coagulation at toner melting point, and toner will stick to either the web 9 or feed roller 81 in a lump. FIG. 6 shows the relationship among toner coagulation, adhesion between toner and web 9, and adhesion between toner and feed roller 81. Coagulation of toner completely molten by passing through the fixing unit 6 is changed by reduced temperature.

As the temperature reduces, the coagulation tends to increase. In the meantime, the adhesion between toner and web 9, and between toner and feed roller 81 are reduced as the temperature falls. Adhesion between toner and an object is affected by the critical surface energy of the object, and the adhesion between the web 9 and toner with higher critical energy is greater. The form of separation of the molten toner varies according to the temperature range I, II or III.

In the temperature range where the melting point of toner is exceeded, toner coagulation is greater than the adhesion with the object, so toner is separated to both the webs 9 and feed roller 81. In the temperature range II where adhesion between toner and web 9, toner coagulation, and adhesion between toner and feed roller 81 are stronger in that order, so almost all molten toner is attached on the web 9 through adhesion of web 9.

In the temperature range III, toner coagulation is strong and toner moves in a lump, but since adhesion between web 9 and feed roller 81 is week, peeling or a similar problem will occur. To avoid reverse transfer of molten toner, the temperature on the surface of the feed roller 81 must be placed under management.

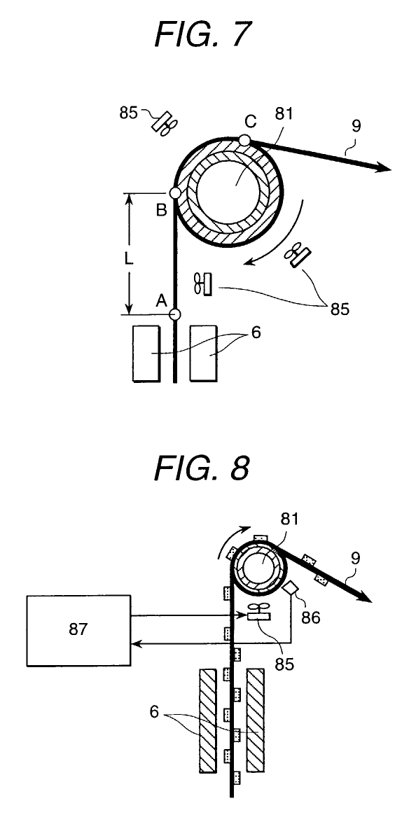

FIG. 7 is a drawing representing the relationship of temperature around the feed roller 81. In this connection, assume that a point on web 9 immediately after the fixing unit 6 is “A”, the starting point for the contact between feed roller 81 and web 9 “B”, and the point of separation between feed roller 81 and web 9 “C”.

The point A immediately after passing through the fixing unit 6 represents the temperature over the melting point of toner. During the course of feed to point B, temperature falls through discharge of heat. If a sufficient length of this section L can be obtained, temperature is reduced and toner sticks to the web 9, without a problem of reverse transfer arising therefrom.

When the high speed and compact configuration are sought, a sufficient length of the section L cannot be secured, so cooling by natural heat discharge will be reduced to a very low level. Further, on the path from point B to point C, cooling by heat conduction through contact between the web 9 and feed roller 81 is possible. However, contact width is small and the web is fed at a high speed, so the time of contact will be very small, with the result that not much heat can be absorbed.

As described above, cooling of the web 9 is insufficient, so cooling means 85 is provided in the third embodiment to cool the feed roller 81 and web 9 forcibly. Air cooling by a fan, water cooling by water running through the feed roller 51, or cooling by a heat pipe or spot cooler can be used as cooling means 85. Use of fan cooling method is preferred for its capacity of cooling the web 9 in the section from the fixing unit 6 to the feed roller 81, cooling the feed roller 81 itself and cooling the contact between the feed roller 81 and web 9, as well as for the possibility of installing the fan at any desired site.

The fans installed at various positions provide the following advantages: A fan installed on the path from point A to point B permits forcible cooling of the web 9 before it reaches the feed roller 81, with the result that heat to be absorbed by the feed roller 81 can be reduced before contact. A fan installed on the path from point B and point C cools both the web 9 and feed roller 81. Both sides of the web 9 are cooled by the fan and feed roller 81. Since the fan is directed to the web 9, the heat of the web to be absorbed by the feed roller 81 is reduced here as well.

A fan over the feed roller 81 going back from point C to point B is intended for direct cooling of the feed roller 81. If cooling of the feed roller 81 is satisfactory, the temperature on the surface of the feed roller 81 at point B can be reduced sufficiently. This makes it possible to maintain a big difference of temperature between the feed roller 81 and web 9 and to ensure efficient heat transfer.

In this case, use of the feed roller 81 described in embodiment 2 allows the heating and cooling cycle of the feed roller 81 to be increased. The temperature of the feed roller 81 can be maintained at a low level in a long-term operation as well.

The temperature where the web 9 and feed roller 81 are separated can be adjusted as follows: The temperature of the surface of the feed roller 81 is measured by a temperature sensor 86 such as a thermister or infrared temperature gauge, and air volume of the fan is controlled. The most preferred temperature measuring point for the feed roller 81 is found on the roller where the web 9 and feed roller 81 are separated.

When the installation of the temperature sensor 86 is taken into account, the temperature on the surface of the feed roller with the web sandwiched in-between is to be measured. This will cause a big error. To avoid this, the temperature sensor 86 is arranged on the feed roller 81 from point C to point B where there is no overlap with the web 9. If measurement is carried out under this condition, high-precision result of measurement can be obtained. Measurement accuracy is higher as the measuring point is closer to the point of separation C.

As described above, by improvement of the mold release property of the feed roller and thermal time constant and adoption of forced cooling method, the present invention prevents the molten toner from reversely transferring, without the roller feeding performance being deteriorated, even when a feed roller is arranged immediately after the fixing unit. This advantage provides an output image characterized by excellent color reproducibility.

What is claimed is:

1. An image forming apparatus comprising:
two web feed means,
tension control means for applying a predetermined tension to a web arranged between said feed means,
walk control means for correcting web position across the width,
image forming means for forming an image on the web,
fixing means for fixing the image formed on the web, and
idle roller constituting a feed path to allow the web to route said means;
the image forming apparatus, characterized in that
a feed roller is provided at an outlet side of said fixing means to change the web feed direction.

2. An image forming apparatus according to claim 1, characterized in that
a member having an excellent mold release property with toners is mounted on an outer periphery of said feed roller.

3. An image forming apparatus according to claim 1 or 2, characterized in that
a member having low heat conductivity is provided inside said member of said feed roll having the excellent mold release property.

4. An image forming apparatus according to any one of claims 1 to 3, characterized by
comprising cooling means for cooling said feed roll and the web.
